(19) United States
(12) Patent Application Publication
(10) Pub. No.: US 2024/0090577 A1
(43) Pub. Date: Mar. 21, 2024

(54) An Aerosol Generating System

(71) Applicant: JT International SA, Geneva (CH)

(72) Inventor: Herman Hijma, Kampen (NL)

(73) Assignee: JT International SA, Geneva (CH)

(21) Appl. No.: 18/274,278

(22) PCT Filed: Jan. 26, 2022
(86) PCT No.: PCT/EP2022/051793

§ 371 Date: Jul. 26, 2023

(30) Foreign Application Priority Data
Feb. 2, 2021 (EP) 21154715.3

(51) Int. Cl. A24F 40/465; A24F 40/20; H05B 6/10

(52) U.S. Cl. CPC A24F 40/465; A24F 40/20; H05B 6/105

(57) ABSTRACT

A heating apparatus for an aerosol generating device includes a heating chamber configured to receive at least part of an aerosol generating substrate; a plurality of inductively heatable susceptors arranged circumferentially with respect to a longitudinal axis of the heating chamber, wherein each susceptor has a substantially planar portion that defines a respective plane; and an inductive coil wrapped around the heating chamber, and shaped such that the coil is parallel to the respective planes defined by the plurality of susceptors.

### FIELD OF INVENTION

The present disclosure relates generally to an aerosol generating device, and more particularly to an aerosol generating device for heating an aerosol generating substrate to generate an aerosol for inhalation by a user.

### BACKGROUND

The popularity and use of reduced-risk or modified-risk devices (also known as aerosol generating devices or vapour generating devices) has grown rapidly in recent years as an alternative to the use of traditional tobacco products. Various devices and systems are available that heat or warm aerosol generating substances to generate an aerosol for inhalation by a user.

A commonly available reduced-risk or modified-risk device is the heated substrate aerosol generating device, or so-called heat-not-burn device. Devices of this type generate an aerosol or vapour by heating an aerosol generating substrate to a temperature typically in the range 150° C. to 300° C. Heating the aerosol generating substrate to a temperature within this range, without burning or combusting the aerosol generating substrate, generates a vapour which typically cools and condenses to form an aerosol for inhalation by a user of the device.

Currently available aerosol generating devices can use one of a number of different approaches to provide heat to the aerosol generating substrate. One such approach is to provide an aerosol generating device which employs an induction heating system. In such a device, an induction coil is provided in the device and an inductively heatable susceptor is provided to heat the aerosol generating substrate. Electrical energy is supplied to the induction coil when a user activates the device which in turn generates an alternating electromagnetic field. The susceptor couples with the electromagnetic field and generates heat which is transferred, for example by conduction, to the aerosol generating substrate and an aerosol is generated as the aerosol generating substrate is heated.

It is generally desirable to rapidly heat an aerosol generating substrate to, and to maintain the aerosol generating substrate at, a temperature sufficiently high to generate a vapour. The present disclosure seeks to provide an aerosol generating device which rapidly heats an aerosol generating substrate to a desired temperature, whilst at the same time maximising the energy efficiency of the device.

### SUMMARY OF THE INVENTION

According to an aspect of the invention, there is provided a heating apparatus for an aerosol generating device comprising a heating chamber configured to receive at least part of an aerosol generating substrate, the heating chamber comprising a chamber wall; a plurality of inductively heatable susceptors arranged circumferentially with respect to a longitudinal axis of the heating chamber, wherein each susceptor has a substantially planar portion that defines a respective plane; and an inductive coil wrapped around the heating chamber, and shaped such that the coil is parallel to the respective planes defined by the plurality of susceptors, wherein the chamber wall has a uniform thickness such that the spacing between the coil and each of the plurality of susceptors is substantially constant across the planar portion.

Advantageously, due to the geometry and positioning of the susceptors and the coil in the heating chamber, it is possible to induce more heat in the susceptors. Also, the generated heat can be more efficiently and uniformly transferred to the aerosol generating substrate to heat it up and generate aerosol for inhalation.

Preferably, the chamber wall defines an interior volume of the heating chamber, and the plurality of susceptors are spaced around an inner surface of the chamber wall.

Preferably, each of the plurality of susceptors has a recess formed along the length of the susceptor, the recess is configured to engage with a corresponding projection defined in the inner surface of the chamber wall.

Preferably, the projection is configured to extend radially inwardly with respect to the longitudinal axis of the heating chamber thereby to compress the aerosol generating substrate positioned, in use, in the heating chamber.

Preferably, the heating chamber has substantially planar portions that coincide with the planar portions of the susceptors. In this way, the coil can be arranged against the planar portions of the heating chambers so that it is arranged in a plane that is parallel with the planar portion of the respective susceptors.

Preferably, the susceptors comprise curved sides in addition to the planar portions. The curved sides may facilitate assembly with the heating chamber, and may help to secure the susceptors in position.

Preferably, the heating chamber is configured to hold four susceptors spaced equidistant from each other such that the planar portion of each of the four susceptors is parallel to the corresponding plane of the coil wrapped around the heating chamber. Thus, the heating chamber may present a cross-sectional shape that is square, or preferably a square with rounded corners to facilitate the winding of the coil.

Preferably, the heating chamber is configured to hold three susceptors spaced equidistant from each other in the heating chamber such that the planar portion of each of the three susceptors is parallel to the corresponding plane of the coil wrapped around the heating chamber. Thus, the heating chamber may present a cross-sectional shape that is triangular, preferably with rounded corners.

Preferably, the coil is configured to generate an electromagnetic field and inductively heat the susceptors to generate aerosol from the aerosol generating substrate when in use.

Preferably, each of the susceptors is elongate in the longitudinal direction of the heating chamber.

Preferably, the sides of the susceptors are flush with the inner surface of the heating chamber. This may be achieved by providing recesses in the wall of the inner surface of the heating chamber in which the susceptors can be received.

Preferably, the heating chamber comprises a substantially non-electrically conductive and non-magnetically permeable material.

Preferably, the heating chamber comprises a heat-resistant plastics material, preferably polyether ether ketone (PEEK).

According to another aspect of the invention, there is provided an aerosol generating system comprising an aerosol generating substrate; and a heating apparatus as described above.

### BRIEF DESCRIPTION OF THE DRAWINGS

FIG. 1 shows a cross-sectional view of an aerosol generating system comprising an aerosol generating device and an aerosol generating article ready to be positioned in a heating chamber of the aerosol generating device;

FIG. 2 shows a detailed cross-sectional view of the heating chamber of the aerosol generating device of FIG. 1, showing one of a plurality of inductively heatable susceptors mounted on an inner surface of the heating chamber;

FIG. 3 shows a cross-sectional view from an end of the heating chamber shown in FIG. 2, showing a plurality of inductively heatable susceptors spaced around a periphery of the heating chamber;

FIGS. 4A-4D are schematics showing the inductively heatable susceptors and a surrounding coil in a triangular arrangement;

FIGS. 5A-5C are schematics showing the inductively heatable susceptors with a recess and projections formed in the heating chamber in a quadrate arrangement;

FIGS. 6A and 6B are schematics showing the inductively heatable susceptors with inwardly extending portions mounted in the heating chamber in a quadrate arrangement;

FIG. 7 is a schematic showing the heating chamber with the coil wrapped around the outer surface of the heating chamber;

FIG. 8A is a schematic showing the heating chamber with inductively heatable susceptors with an alternative geometry; and

FIG. 8B is a schematic showing the heating chamber with the aerosol generating substrate contained inside the heating chamber of FIG. 8A.

### DETAILED DESCRIPTION

Embodiments of the present disclosure will now be described by way of example only and with reference to the accompanying drawings.

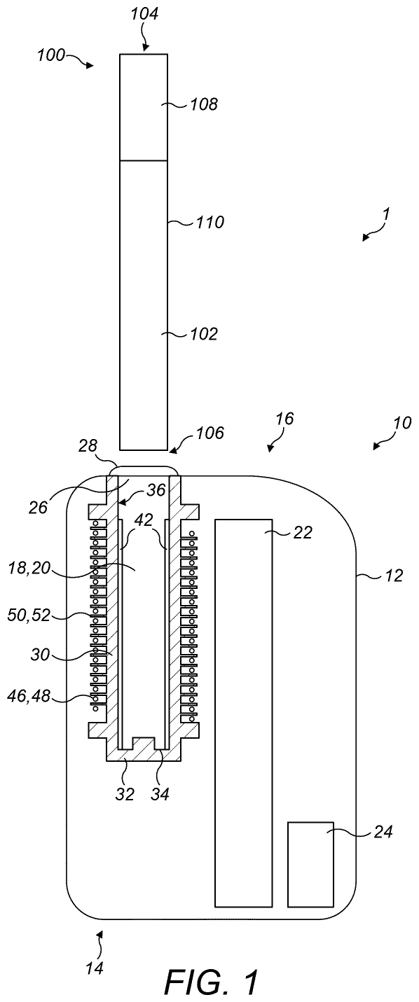

Referring initially to FIG. 1, there is shown diagrammatically an example of an aerosol generating system 1. The aerosol generating system 1 comprises an aerosol generating device 10 and an aerosol generating article 100 for use with the device 10. The aerosol generating device 10 comprises a main body 12 housing various components of the aerosol generating device 10. The main body 12 can have any shape that is sized to fit the components described in the various embodiments set out herein and to be comfortably held by a user unaided, in a single hand.

A first end 14 of the aerosol generating device 10, shown towards the bottom of FIG. 1, is described for convenience as a distal, bottom, base or lower end of the aerosol generating device 10. A second end 16 of the aerosol generating device 10, shown towards the top of FIG. 1, is described as a proximal, top or upper end of the aerosol generating device 10. During use, the user typically orients the aerosol generating device 10 with the first end 14 downward and/or in a distal position with respect to the user's mouth and the second end 16 upward and/or in a proximate position with respect to the user's mouth.

The aerosol generating device 10 comprises a heating chamber 18 positioned in the main body 12. The heating chamber 18 defines an interior volume in the form of a cavity 20 having a substantially cylindrical cross-section for receiving an aerosol generating article 100. The heating chamber 18 has a longitudinal axis defining a longitudinal direction and is formed of a heat-resistant plastics material, such as polyether ether ketone (PEEK). The aerosol generating device 10 further comprises a power source 22, for example one or more batteries which may be rechargeable, and a controller 24.

The heating chamber 18 is open towards the second end 16 of the aerosol generating device 10. In other words, the heating chamber 18 has an open first end 26 towards the second end 16 of the aerosol generating device 10. The heating chamber 18 is typically held spaced apart from the inner surface of the main body 12 to minimise heat transfer to the main body 12.

The aerosol generating device 10 can optionally include a sliding cover 28 movable transversely between a closed position in which it covers the open first end 26 of the heating chamber 18 to prevent access to the heating chamber 18 and an open position in which it exposes the open first end 26 of the heating chamber 18 to provide access to the heating chamber 18. The sliding cover 28 can be biased to the closed position in some embodiments.

The heating chamber 18, and specifically the cavity 20, is arranged to receive a correspondingly shaped generally cylindrical or rod-shaped aerosol generating article 100. Typically, the aerosol generating article 100 typically comprises a pre-packaged aerosol generating substrate 102. The aerosol generating article 100 is a disposable and replaceable article (also known as a “consumable”) which may, for example, contain tobacco as the aerosol generating substrate 102. The aerosol generating article 100 has a proximal end 104 (or mouth end) and a distal end 106. The aerosol generating article 100 further comprises a mouthpiece segment 108 positioned downstream of the aerosol generating substrate 102. The aerosol generating substrate 102 and the mouthpiece segment 108 are arranged in coaxial alignment inside a wrapper 110 (e.g., a paper wrapper) to hold the components in position to form the rod-shaped aerosol generating article 100.

The mouthpiece segment 108 can comprise one or more of the following components (not shown in detail) arranged sequentially and in co-axial alignment in a downstream direction, in other words from the distal end 106 towards the proximal (mouth) end 104 of the aerosol generating article 100: a cooling segment, a center hole segment and a filter segment. The cooling segment typically comprises a hollow paper tube having a thickness which is greater than the thickness of the wrapper 110. The center hole segment may comprise a cured mixture containing cellulose acetate fibres and a plasticizer, and functions to increase the strength of the mouthpiece segment 108. The filter segment typically comprises cellulose acetate fibres and acts as a mouthpiece filter. As heated vapour flows from the aerosol generating substrate 102 towards the proximal (mouth) end 104 of the aerosol generating article 100, the vapour cools and condenses as it passes through the cooling segment and the center hole segment to form an aerosol with suitable characteristics for inhalation by a user through the filter segment.

The heating chamber 18 has a side wall (or chamber wall) 30 extending between a base 32, located at a second end 34 of the heating chamber 18, and the open first end 26. The side wall 30 and the base 32 are connected to each another and can be integrally formed as a single piece. In the illustrated embodiment, the side wall 30 is tubular and, more specifically, cylindrical. In other embodiments, the side wall 30 can have other suitable shapes, such as a tube with an elliptical or polygonal cross section. In yet further embodiments, the side wall 30 can be tapered.

In the illustrated embodiment, the base 32 of the heating chamber 18 is closed, e.g. sealed or air-tight. That is, the heating chamber 18 is cup-shaped. This can ensure that air drawn from the open first end 26 is prevented by the base 32 from flowing out of the second end 34 and is instead guided through the aerosol generating substrate 102. It can also ensure that a user inserts the aerosol generating article 100 into the heating chamber 18 an intended distance and no further.

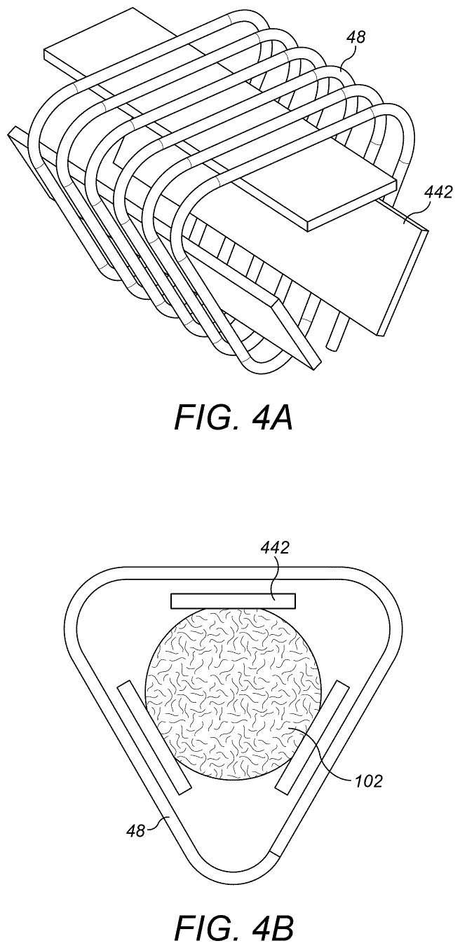

The side wall 30 of the heating chamber 18 has an inner surface 36 and an outer surface 38. Optionally, a plurality of susceptor mounts 40 are formed in the inner surface 36 and are circumferentially spaced around the inner surface 36 with respect to a longitudinal axis of the heating chamber 18. The aerosol generating device 10 comprises a plurality of inductively heatable susceptors 42 mounted on the susceptor mounts 40 and, thus, the inductively heatable susceptors 42 are circumferentially spaced around a periphery 44 of the heating chamber 18, as shown in FIG. 3.

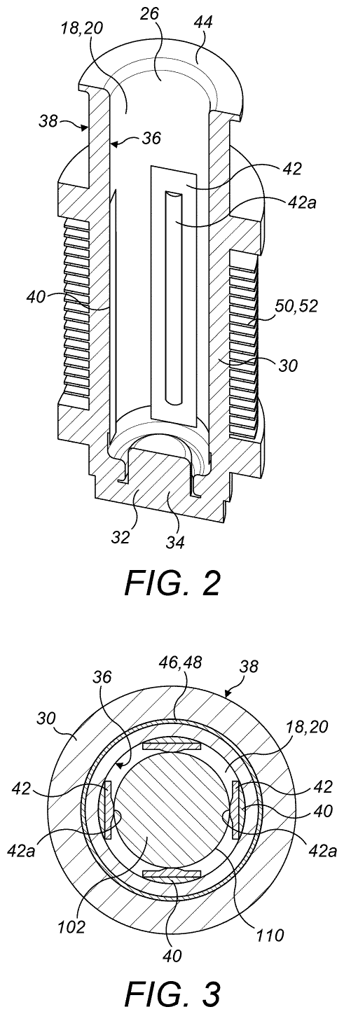

As shown in FIG. 2, the inductively heatable susceptors 42 are elongate in the longitudinal direction of the heating chamber 18 and are substantially planer. Each inductively heatable susceptor 42 may have an inwardly extension portion 42a in a radial direction from the side wall 30. The inwardly extension portion 42a is formed during fabrication of the inductively heatable susceptors 42.

The aerosol generating device 10 comprises an electromagnetic field generator 46 for generating an electromagnetic field. The electromagnetic field generator 46 comprises a substantially helical induction coil 48. The induction coil 48 may have a circular, triangular, or square cross-section and extends helically around the heating chamber 18. The induction coil 48 can be energised by the power source 22 and controller 24. The controller 24 includes, amongst other electronic components, an inverter which is arranged to convert a direct current from the power source 22 into an alternating high-frequency current for the induction coil 48.

The side wall 30 of the heating chamber 18 may include a coil support structure 50 formed in the outer surface 38. In the illustrated example, the coil support structure 50 comprises a coil support groove 52 which extends helically around the outer surface 38. The induction coil 48 is positioned in the coil support groove 52 and is, thus, securely and optimally positioned with respect to the inductively heatable susceptors 42.

In order to use the aerosol generating device 10, a user displaces the sliding cover 28 (if present) from the closed position shown in FIG. 1 to the open position shown in FIG. 2. The user then inserts an aerosol generating article 100 through the open first end 26 into the heating chamber 18, so that the aerosol generating substrate 102 is received in the cavity 20 and so that the proximal end 104 of the aerosol generating article 100 is positioned at the open first end 26 of the heating chamber 18, with at least part of the mouthpiece segment 108 projecting from the open first end 36 to permit engagement by a user's lips.

Upon activation of the aerosol generating device 10 by a user, the induction coil 48 is energised by the power source 22 and controller 24 which supply an alternating electrical current to the induction coil 48, and an alternating and time-varying electromagnetic field is thereby produced by the induction coil 48. This couples with the inductively heatable susceptors 42 and generates eddy currents and/or magnetic hysteresis losses in the susceptors 42 causing them to heat up. The heat is then transferred from the inductively heatable susceptors 42 to the aerosol generating substrate 102, for example by conduction, radiation and convection. This results in heating of the aerosol generating substrate 102 without combustion or burning, and a vapour is thereby generated. The generated vapour cools and condenses to form an aerosol which can be inhaled by a user of the aerosol generating device 10 through the mouthpiece segment 108, and more particularly through the filter segment.

The vaporisation of the aerosol generating substrate 102 is facilitated by the addition of air from the surrounding environment, for example through the open first end 26 of the heating chamber 18, the air being heated as it flows between the wrapper 110 of the aerosol generating article 100 and the inner surface 36 of the side wall 30. More particularly, when a user sucks on the filter segment, air is drawn into the heating chamber 18 through the open first end 26. The air entering the heating chamber 18 flows from the open first end 26 towards the closed second end 34, between the wrapper 110 and the inner surface 36 of the side wall 30. As described later, projections may extend into the heating chamber 18 by a sufficient distance to at least contact the outer surface of the aerosol generating article 100, and typically to cause at least some degree of compression of the aerosol generating article 100. Consequently, there is no air gap all the way around the heating chamber 18 in the circumferential direction. Instead, there are air flow paths in the circumferential regions (equally spaced gap regions) between the projections along which air flows from the open first end 26 towards the closed second end 34 of the heating chamber 18. In some examples, there may be more or less than projections and, thus, a corresponding number of air flow paths formed by the gap regions between the projections. When the air reaches the closed second end 34 of the heating chamber 18, it turns through approximately 180° and enters the distal end 106 of the aerosol generating article 100. The air is then drawn through the aerosol generating article, from the distal end 106 towards the proximal (mouth) end 104 along with the generated vapour.

A user can continue to inhale aerosol all the time that the aerosol generating substrate 102 is able to continue to produce a vapour, e.g. all the time that the aerosol generating substrate 102 has vaporisable components left to vaporise into a suitable vapour. The controller 24 can adjust the magnitude of the alternating electrical current passed through the induction coil 48 to ensure that the temperature of the inductively heatable susceptors 42, and in turn the temperature of the aerosol generating substrate 102, does not exceed a threshold level. Specifically, at a particular temperature, which depends on the constitution of the aerosol generating substrate 102, the aerosol generating substrate 102 will begin to burn. This is not a desirable effect and temperatures above and at this temperature are avoided.

To assist with this, in some examples the aerosol generating device 10 is provided with a temperature sensor (not shown). The controller 24 is arranged to receive an indication of the temperature of the aerosol generating substrate 102 from the temperature sensor and to use the temperature indication to control the magnitude of the alternating electrical current supplied to the induction coil 48. In one example, the controller 24 may supply a first magnitude of electrical current to the induction coil 48 for a first time period to heat the inductively heatable susceptors 42 to a first temperature.

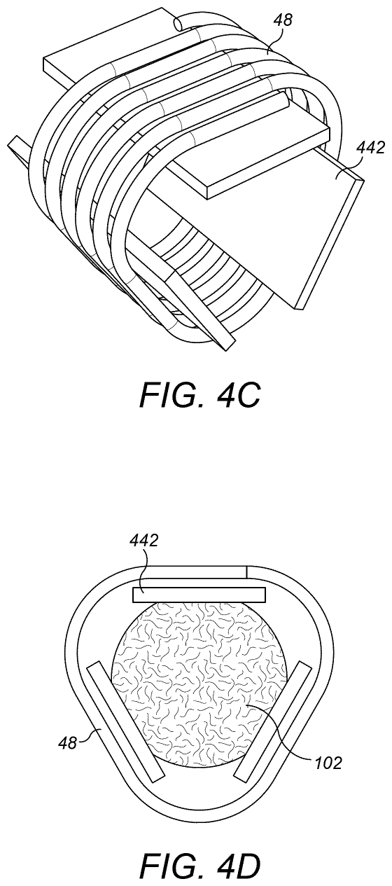

FIG. 4A shows a simplified view of an arrangement of susceptors 442 and the coil 48 in the hearing chamber 18 according to one embodiment of the invention. Three substantially planar susceptors 442 are arranged around the longitudinal axis of the heating chamber 18 such that the susceptors 442 are equidistant from each other. The coil 48, wrapped around the heating chamber 18 (not shown here for the sake of simplicity), is triangular-shaped. The coil 48 has straight sides and rounded corners. Each straight portion of the coil 48 in the triangle is substantially parallel to the plane defined by a corresponding susceptors 442. In other words, the susceptors 442 are width-wise parallel to the corresponding windings of the coil 48. There is a constant gap maintained between the susceptors 442 and the coil 48 by the virtue of the body of the heating chamber 18 between the susceptors 442 and the coil 48. As a large planar surface of the susceptors 442 is inductively exposed to the coil 48, when the coil 48 is energised, a large amount of flux is induced in the susceptors 442 to generate heat. It is to be noted that the heating chamber 18 is positioned between the susceptors 442 and the coil 48 and is omitted from FIGS. 4A-4D in order to show more clearly the susceptors 442 and the coil 48.

FIG. 4B shows an end view of the arrangement of FIG. 4A described above, with the aerosol generating substrate 102 contained inside the heating chamber 18. As can be seen, the aerosol generating substrate 102 is in close contact with the susceptors 442 and therefore the heat from the susceptors 442 is easily and uniformly transferred to the aerosol generating substrate 102 for aerosol generation.

FIGS. 4C and 4D show an arrangement similar to that shown in FIGS. 4A and 4B, except that the susceptors 442 are wider and the coil 48 has more curved edges. In this arrangement, the susceptors 442 have a much larger planar area exposed to the coil 48 and are more densely packed to minimise air gaps. Due to this, more flux is induced and the leakage is minimised thus generating more heat. Moreover, as shown in FIG. 4D, as the susceptors 442 have greater width, more of the aerosol generating substrate 102 comes into contact with the susceptors 442 resulting in more efficient heat transfer for vaporisation.

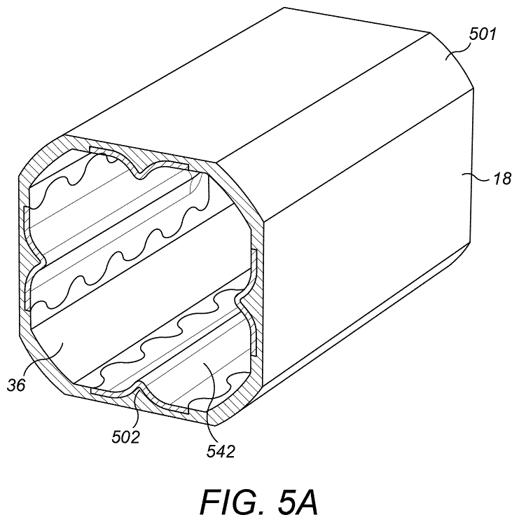

FIG. 5A shows the heating chamber 18 with susceptors 542 according to another embodiment of the invention. In this embodiment, the heating chamber 18 is substantially square or cuboidal-shaped and is configured to hold four susceptors 542 on the inner surface 36 in a quadrate arrangement. Edges 501 of the heating chamber 18 may be bevelled to aid wrapping of the coil 48 around the heating chamber 18. The susceptors 542 may have curved, wavy sides. In one implementation, the susceptors 542 are mounted such that the sides of the susceptors 542 are flush with the chamber walls of the inner surface 36. This is achieved by fitting the susceptors 542 in cut-outs that are defined in the inner surface 36.

Each of the susceptors 542 has a recess 502 formed longitudinally along its length such that the recess engages with a corresponding projection 503 formed on the chamber walls of the inner surface 36 of the heating chamber 18. As can be seen more clearly from FIG. 5B, the projection 503 protrudes outwards from the inner surface 36 of the heating chamber 18. The projection 503 aids in holding and compressing the aerosol generating substrate 102 inside the heating chamber 18.

FIG. 5C shows the heating chamber 18 with the aerosol generating substrate 102 contained inside it. As can be seen, the projections 503 formed in the chamber walls of the inner surface 36 firmly hold and compress the aerosol generating substrate 102 inside the heating chamber 18.

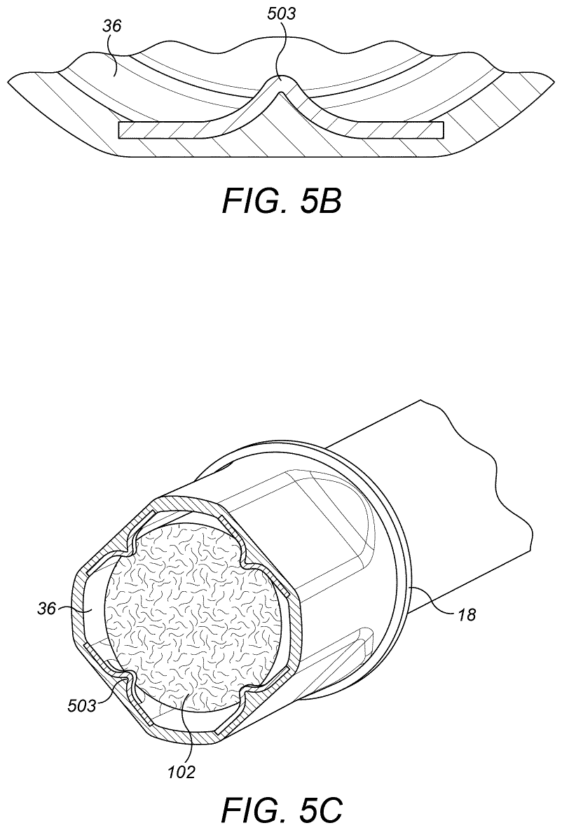

FIGS. 6A and 6B show the heating chamber 18 with susceptors 642 according to another embodiment of the invention. In this embodiment, each of the susceptors 642 is mounted directly on a corresponding chamber wall of the inner surface 36. The susceptors 642 in this embodiment may also have curved, wavy sides and may be made flush with the inner surface 36 of the heating chamber 18.

Each of the susceptors 642 has the inwardly extending portion 42a formed at least partly along the length of the susceptor. The inwardly extending portion 42a is a protrusion which serves the same purpose as the recess 502 and the projection 503 in the FIGS. 5A-5B. The inwardly extending portions 42a extend towards and contact the aerosol generating substrate 102. The inwardly extending portions 42a extend radially inwardly into the heating chamber 18 by a sufficient extent to reduce the effective cross-sectional area of the heating chamber 18. The inwardly extending portions 42a, similar to the projections 503 in the embodiment of FIGS. 5A-5B, thus form a friction fit with the aerosol generating substrate 102, and more particularly with the wrapper 110 of the aerosol generating article 100, and may cause compression of the aerosol generating substrate 102. The compression of the aerosol generating substrate 102 improves thermal conduction through the aerosol generating substrate 102, for example by eliminating air gaps, and each inwardly extending portion 42a may extend inwardly across the heating chamber 18 by a distance of between 3% and 7%, for example about 5% of the distance across the heating chamber 18.

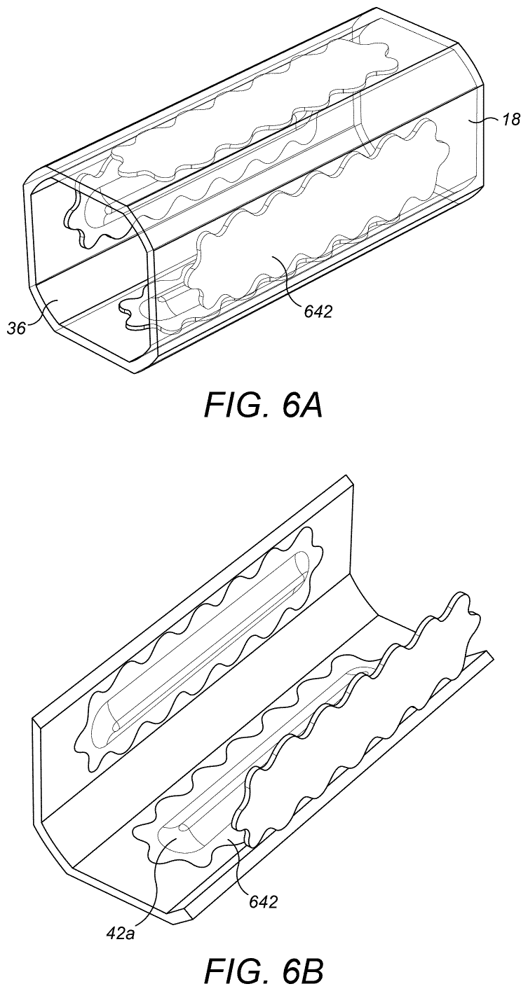

FIG. 7 shows a simplified view of the heating chamber 18 with the coil 48 wrapped around it. In this embodiment, the heating chamber 18 is substantially tubular with four flattened sides suitable for mounting four susceptors (not shown in the figure) on the inner surface 36. The coil 48 is square shaped and has four defined sides. The coil 48 is wrapped around the heating chamber 18 such that each side of the coil 48 is parallel to the plane of the corresponding susceptor along each of the four sides of the heating chamber 18. The thickness of the walls of the heating chamber 18 is substantially uniform so that a constant gap or separation is maintained between the coil 18 and the susceptors.

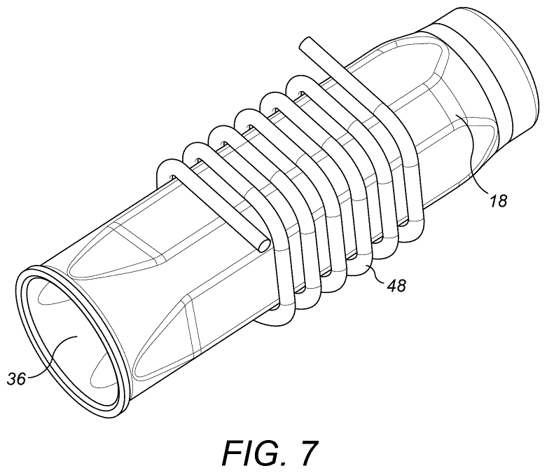

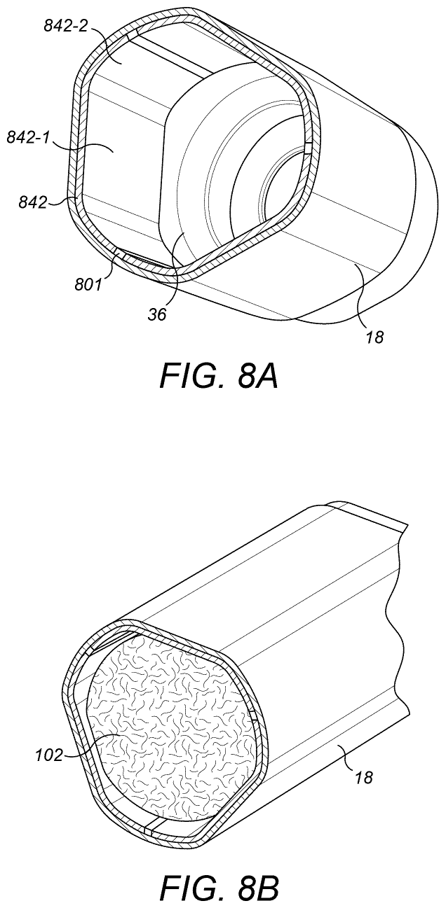

FIG. 8A shows the heating chamber 18 with susceptors 842 of alternate geometry. In this embodiment, the heating chamber 18 has a triangular cross-section with curved edges. The susceptors 842 are formed with a flat middle part 842-1 and curved side parts 842-2 on either sides of the flat middle part 842-1 such that the susceptors 842 conform to the curved edges of the heating chamber 18. Three susceptors 842 are mounted on the inner surface 36 of the heating chamber 18 with a small insulating gap 801 between adjacent susceptors 842. The insulating gap 801 is formed inherently by the body of the heating chamber 18. However, it may be possible to provide an insulating material between the adjacent susceptors 842. In this arrangement, a substantial surface of the heating chamber 18 is covered with the susceptors 842, therefore more heat is generated when the coil (not shown) is wrapped around the heating chamber 18. Moreover, when the aerosol generating substrate 102 is provided in the heating chamber 18, as shown in FIG. 8B, it comes into contact with almost entire surface of the susceptors 842, thus resulting in greater and more uniform heat transfer.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. A heating apparatus for an aerosol generating device comprising:
a heating chamber configured to receive at least part of an aerosol generating substrate, the heating chamber comprising a chamber wall;
a plurality of inductively heatable susceptors arranged circumferentially with respect to a longitudinal axis of the heating chamber, wherein each susceptor has a substantially planar portion that defines a respective plane; and
an inductive coil wrapped around the heating chamber, and shaped such that the coil is parallel to respective planes defined by the plurality of susceptors, wherein the chamber wall has a uniform thickness such that a spacing between the coil and each of the plurality of susceptors is substantially constant across the planar portion.

2. The heating apparatus according to claim 1, wherein chamber wall defines an interior volume of the heating chamber, and the plurality of susceptors are spaced around an inner surface of the chamber wall.

3. The heating apparatus according to claim 2, wherein each of the plurality of susceptors has a recess formed along a length of the susceptor, the recess is configured to engage with a corresponding projection defined in the inner surface of the chamber wall.

4. The heating apparatus according to claim 3, wherein the projection is configured to extend radially inwardly with respect to the longitudinal axis of the heating chamber thereby to compress the aerosol generating substrate positioned, in use, in the heating chamber.

5. The heating apparatus according to claim 1, wherein the heating chamber has substantially planar portions that coincide with the planar portions of the susceptors.

6. The heating apparatus according to claim 1, wherein the plurality of susceptors comprise curved sides in addition to the planar portions.

7. The heating apparatus according to claim 1, wherein the heating chamber is configured to hold four of the plurality of susceptors spaced equidistant from each other such that the planar portion of each of the four susceptors is parallel to a corresponding plane of the coil wrapped around the heating chamber.

8. The heating apparatus according to claim 1, wherein the heating chamber is configured to hold three of the plurality of susceptors spaced equidistant from each other in the heating chamber such that the planar portion of each of the three susceptors is parallel to a corresponding plane of the coil wrapped around the heating chamber.

9. The heating apparatus according to claim 1, wherein the coil is configured to generate an electromagnetic field and inductively heat the plurality of susceptors to generate aerosol from the aerosol generating substrate when in use.

10. The heating apparatus according to claim 1, wherein each of the plurality of susceptors is elongate in the longitudinal direction of the heating chamber.

11. The heating apparatus according to claim 2, wherein sides of the plurality of susceptors are flush with the inner surface of the heating chamber.

12. The heating apparatus according to claim 1, wherein the heating chamber comprises a substantially non-electrically conductive and non-magnetically permeable material.

13. The heating apparatus according to claim 12, wherein the heating chamber comprises a heat-resistant plastics material, preferably polyether ether ketone (PEEK).

14. An aerosol generating system comprising:
an aerosol generating substrate; and
a heating apparatus according to claim 1.
